(19) United States
(12) Patent Application Publication
(10) Pub. No.: US 2024/0237692 A1
(43) Pub. Date: Jul. 18, 2024

(54) AMYLOPECTIN STARCH FOR BINDING OF MEAT PRODUCTS

(71) Applicant: Coöperatie Koninklijke Avebe U.A., Veendam (NL)

(72) Inventors: Nikola STANISIC, Groningen (NL); Zhenghong CHEN, Groningen (NL); Roelfina Willemina Antonia THÜRKOW, Assen (NL); Jacob BERGSMA, Haren (NL)

(73) Assignee: Coöperatie Koninklijke Avebe U.A., Veendam (NL)

(21) Appl. No.: 18/564,360

(22) PCT Filed: May 27, 2022
(86) PCT No.: PCT/NL2022/050294

§ 371 Date: Nov. 27, 2023

(30) Foreign Application Priority Data
May 28, 2021 (EP) 21176505.2

(51) Int. Cl. A23L 29/219; A23L 13/40; A23L 13/60

(52) U.S. Cl. CPC A23L 29/219; A23L 13/426; A23L 13/428; A23L 13/60

(57) ABSTRACT

The invention provides a non-inhibited granular amylopectin potato starch with a decreased gelatinization temperature, which is highly suitable for use in pasteurized meat products.

### BACKGROUND

Starches are widely used in the meat industry for reasons of water binding, improvement of texture and sliceability.

Starch and modified starch are used as such or as a blend, often in combination with other hydrocolloids and/or proteins. With the currently known starch types however a combination of high water binding and—holding, as well as improved firmness cannot be achieved.

For example, native potato starch provides reasonable firmness and water holding, whereas corn starch provides high firmness but poor water binding and water holding. A regular amylopectin potato starch can provide very high water holding but does not provide firmness. The present invention provides a starch which is usable in a pasteurized meat product to provide both high water holding and high firmness.

Liu (Liu, K. Int. J. Biological Macromolecules, 2019, 132, 1044-1050) described an amylopectin potato starch dried in an oven at a temperature of 110° C. for a duration between 0.5 and 2.5 hours. Liu reported a reduction in pasting (gelatinization) temperature and an increase in peak viscosity of the dried starches compared to native amylopectin potato starch, but the changes were minor, and no reference was made to potential applications.

### FIGURES

FIG. 1: Gelatinisation temperatures (T_{g}) of APS, OD4 and Pn3 (FIG. 1a), and visualization using light microscopy of APS (FIG. 1b), OD4 (FIG. 1c) and Pn3 (FIG. 1d).

FIG. 2: water holding and firmness of the meat products prepared in experiment 2a (FIG. 2a), experiment 2b (FIG. 2b), experiment 2c (FIG. 2c), and experiment 2d (FIG. 2d), and experiment 2e (FIG. 2e).

FIG. 3: properties of different starch types in pasteurized meat products.

### DETAILED DESCRIPTION

The invention provides a non-inhibited granular amylopectin potato starch obtainable by a process comprising drying a native granular amylopectin potato starch to a moisture content of 2-12 wt. %, preferably 3-9 wt. %, which non-inhibited granular amylopectin potato starch is characterized by a gelatinization temperature, measured using RVA at 30 wt. % dry solids, which is more than 2.5° C., preferably 3-8° C., lower than the gelatinization temperature of the native granular amylopectin potato starch prior to drying. The native granular amylopectin potato starch prior to drying is preferably a starch at equilibrium moisture content under normal atmospheric conditions. (10-30° C., preferably 18-22° C., relative humidity of 40-75 wt. %, preferably 40-60 wt. %). The equilibrium moisture content under such conditions is at least 15 wt. %, preferably 15-40 wt. %, more preferably 18-20 wt. %.

Phrases “lower than” and “higher than”, as used herein, can be substituted for appropriate well-known terms, such as for example “below” and “above”, and similar wording.

In preferred embodiments, the non-inhibited granular amylopectin potato starch is obtained through the process described herein.

The invention alternatively provides a non-inhibited granular amylopectin potato starch obtainable by a process comprising drying a native granular amylopectin potato starch to a moisture content of 2-12 wt. %, preferably 3-9 wt. %, which non-inhibited granular amylopectin potato starch is characterized by a gelatinization temperature, measured using RVA at 30 wt. % dry solids, of 59-65° C.

A starch of the invention has unexpected favorable properties, which render the starch of the invention suitable for use in a pasteurized meat product.

Pasteurized meat products (such as ham, sausages, and the like) are based on whole or comminuted meat, combined with salt, phosphates and water. After combining, the phosphates and salt extract meat protein from the meat, and the “free” (“extracted”; “liberated”) meat protein binds the product. The meat product is subsequently pasteurized (“cooked”) to a core temperature of 70-80° C., in which process meat protein denatures at around 55-65° C. Said denaturation of meat protein decreases its ability to bind water. Thus, water is liberated in the process of cooking the meat product.

Regular starch is often added with the salts. Starch has three functions in this system: water binding (by gelatinization, i.e. taking up water), water holding (the inverse of syneresis), and firmness (related to gel strength of the starch). But starch may also be partially degraded by the meat enzymes, which decreases the water binding capability.

Regular native amylopectin potato starch (“APS”; comprising more than 95 wt. %, preferably more than 98 wt. % of amylopectin), for example, provides a pasteurized meat product with a high water holding, because the swelling of APS is less influenced by the presence of salt compared to non-amylopectin potato starch. However, APS results in a low firmness of the meat product, due to the low gel strength. Also, APS has a gelatinization temperature of 65° C., so that water released by the meat proteins around the denaturing temperature is not bound immediately by the starch. Due to the high gelatinization temperature, APS is however relatively stable against degradation by meat proteins.

Application of a regular native potato starch (“NPS”, comprising about 80 wt. % amylopectin and about 20 wt. % amylose) in a meat product normally leads to a relatively good firmness due to the relatively high gel strength.

The lower gelatinization temperature of 62° C. of NPS, relative to APS, provides for good water binding, as water released by the denaturing meat protein can be bound by the starch immediately. However, NPS binds less water than APS, and has higher syneresis, thus leading to low water holding. In addition, NPS can be degraded by meat protein to a significant extent.

The invention resides in the insight that drying of APS to a moisture content of 2-12 wt. %, preferably 3-9 wt. %, more preferably 3-7 wt. % alters the properties of the APS starch granule, which change in properties is maintained also after rehydration. Drying of APS results in a lower gelatinization temperature, a faster release of starch into solution as measured by the enzymatic digestibility and the tendency to fracture. Applying such starch in a pasteurized meat product results in a meat product with increased water holding and increased firmness.

In much preferred embodiments, drying is performed under the application of at least some physical stress, because this results in a higher degree of the altered properties. In further preferred embodiments, the drying is performed under neutral conditions. The pH of the starch to be dried, as well as the pH during drying, is preferably 5-9, more preferably 6-8.

In alternative preferred embodiments, the non-inhibited granular amylopectin potato starch has one or more, preferably at least two, and more preferably all, of the following characteristics:
A gelatinization temperature, measured using RVA at 30 wt. % dry solids, of 59-65° C. The gelatinization temperature is the temperature from which temperature onwards the starch starts to significantly absorb water.
An enzymatic digestibility, measured using the standardized amylase degradation method (see below), which is higher than the enzymatic digestibility of the native granular amylopectin potato starch prior to drying. Enzymatic digestibility reflects the amount of starch that leaches out the starch granules and that is able to bind free water before the temperature reaches the point where the starch granule starts to gelatinize.
An enzymatic digestibility, measured using the standardized amylase degradation method, of at least 8.5 mg/g dry substance, preferably 9-18 mg/g.
A breakdown, measured using RVA at 6.4 wt. % dry solids, which is higher than the breakdown of the native granular amylopectin potato starch prior to drying. Breakdown reflects the decrease in viscosity relative to peak viscosity, and is therefore a measure for how well a starch granule is disrupted.
A breakdown, measured using RVA at 6.4 wt. % dry solids, of at least 65%, preferably at least 65.5%.
A peak viscosity, measured using RVA at 6.4 wt. % dry solids, which is higher than the peak viscosity of the native granular amylopectin potato starch prior to drying. Peak viscosity is a measure for swelling strength of a granule, an important attribute for water holding.
A peak viscosity, measured using RVA at 6.4 wt. % dry solids, of at least 3500 mPa·s, preferably at least 3550 mPa·s, more preferably at least 3600 mPa·s.

A starch of the invention has the advantage that the gelatinization temperature (Tg) is lower, relative to the non-dried starch (APS). At the same time, enzymatic digestibility is increased. This indicates that water holding of granular amylopectin potato starch has improved by the process of drying to 2-12 wt. %, while at the same time the water holding occurs at lower temperature. Peak viscosity however is maintained, reflective of strong water absorption.

Without wishing to be bound by theory, it is speculated that the process of drying a granular amylopectin potato starch damages the starch granules in such a way that the granule fragments more easily. This is confirmed by light microscopy.

Merely dried starch (to 2-12 wt. % moisture) displays cracks which were not present in the starch prior to drying, whereas drying under increased physical stress results in similar cracks which were not initially present, but furthermore results in a modest degree of granular fragmentation.

Consequently, in much preferred embodiments, the non-inhibited granular amylopectin potato starch of the invention is obtained by a process comprising drying a native granular amylopectin potato starch to a moisture content of 2-12 wt. %, preferably 3-9 wt. %, more preferably 3-7 wt. %, under the application of physical stress.

Physical stress, as used herein, is a generally known phrase in the context of drying. Drying under the application of physical stress refers to methods of drying which inherently come with a form of impact pressure on the material to be dried. This impact pressure can stem from collision of starch granules with the surface of the equipment or with other starch granules during the drying process.

Much preferred methods of drying under the application of physical stress are pneumatic drying and fluidized bed drying.

A granular amylopectin potato starch is a conventional ingredient in the food industry. An example of a commercially available granular amylopectin potato starch is Eliane 100 from Avebe.

Inhibition of starch is a generally known process. Thermal inhibition of starch is the process in which starch is crosslinked by heating the starch, generally under alkaline conditions (pH of above 9 up to 14). For inhibition to occur, a starch must generally be dried to a moisture content of less than 2 wt. % with simultaneous heating to a temperature of at least 100° C., generally about 120-180° C. Thus, a non-inhibited starch is a starch which has not been subjected to a temperature of more than 100° C. at a moisture content of less than 2 wt. %. Although the process for obtaining thermally inhibited starch also comprises a drying step, thermally inhibited starch does not provide the advantages of increased water holding and increased firmness in pasteurized meat as observed for the starch of the invention. FIG. 3 depicts an overview of the effect of the starch of the invention compared to other starches in the field of pasteurized meats.

The non-inhibited granular amylopectin potato starch of the invention is characterized by the presence of cracks and by fragmenting, and is not crosslinked, whereas an inhibited granular amylopectin potato starch is characterized by an intact granular structure, which is strengthened relative to the non-inhibited product due to the presence of crosslinks.

“Granular”, as used herein, refers to the structure of starch as it occurs in nature. In nature, starch is present in small particles, which are called “starch granules”. The starch of the invention largely retains the granular structure, albeit with some fragmentation and cracking. The starch of the invention is granular, but the starch granules have been weakened by the drying process.

The granular structure of starch is lost upon gelatinization (as is generally known), because starch gelatinization is the process in which the starch granule molecular structure (amorphous and crystalline regions of amylopectin and (for NPS) amylose) is lost by individual dissolution of the amylopectin and/or amylose molecules. Consequently, a granular starch is a starch which has not been gelatinized.

The starch of the invention is obtainable by a process comprising drying a native granular amylopectin potato starch to a moisture content of 2-12 wt. %, preferably 3-9 wt. %. Said process affects the granular structure of the starch in a mechanistically yet unknown way, which results in granular damage.

The starch to be dried is a native granular amylopectin potato starch. Native in this regard means that the starch granule has not been modified prior to drying, such as by etherification, esterification or amidation of the starch granule, nor by oxidation, enzymatic action or basic or acidic hydrolysis of the starch granule. A native starch is the starch granule after isolation from the source material (potato), without further processing of said starch to alter its properties.

Drying of said native granular amylopectin potato starch can be drying in the absence of concomitant physical stress, such as by oven drying. Oven drying to the recited moisture content can be achieved at temperatures above 70, preferably 75-99° C. Higher temperatures can be applied, as long as the moisture content of the starch is carefully monitored so as to prevent the moisture content becoming lower than 2 wt. %, thereby preventing inhibition. For example, oven drying can be achieved by drying at a temperature of at least 100° C., preferably at least 110° C., more preferably at least 120° C., such as 100-180° C., or 110-150° C. Overall, temperatures of 70-180° C. are usable, such as 75-150° C., preferably 80-130° C.

In preferred embodiments, the drying to a moisture content of 2-12 wt. %, preferably 3-9 wt. %, more preferably 3-7 wt. % is achieved under concomitant physical stress, such as by pneumatic drying, cyclone drying, dispersion drying or fluid bed drying.

Pneumatic drying is also known as flash drying. Pneumatic drying, in the present context, comprises introduction of a granular amylopectin potato starch into a pneumatic dryer. The moisture content of the native granular amylopectin potato starch to be dried is generally higher than 15 wt. %, preferably higher than 18 wt. %, such as 18-42 wt. %. The inlet temperature of the pneumatic dryer can be set to 110-175° C., preferably 140-175° C., and the outlet temperature can be 70-135° C., preferably 75-125° C. The residence time must be set such that inhibition of starch does not occur. A suitable residence time can be 1-200 seconds, preferably 2-100 seconds, more preferably 3-30 seconds. By increasing the residence time, the output temperature increases and the flow decreases.

Fluid bed drying is a process in which starch is dried in a whirlwind of hot air, thereby drying the starch while simultaneously applying physical stress. Suitable temperatures can be up to 140° C., but in particular at higher temperatures, the residence time must be set such that inhibition does not occur. The advantage of a fluid bed dryer is that the residence time can be easily adapte.

A cyclone dryer is a pneumatic dryer which provides increased residence time. The cyclone dryer is a cylindrical shell, divided by conical orifices into several chambers. Product is fed sideways at the bottom of the cyclone dryer, for example from a pneumatic dryer, together with the drying air.

Rotational movement of air and particles continues to the top of the dryer thereby achieving residence times up to 30 minutes which allows for reduction of the moisture content under concomitant physical stress.

A dispersion dryer also dries using hot air, which is supplied from a tank, equipped with an air distribution plate at the bottom. Heated air is introduced spirally from the bottom via the plate. The feed is introduced via a central pipe in the tank and distributed horizontally above the air distribution plate by means of a rotating dispersor. The air transports the product spirally through the tank while drying. Advantage of a dispersion dryer is an increased residence time which allows to reach a low moisture content, under concomitant physical stress.

Other alternatives to dry granular starch or starch filter cake are a Whirl Flash™ dryer from Larsson or a Zeta Dryer from SiccaDania. The product is dispersed in hot air using fast rotating blades which allows higher inlet temperatures compared to traditional flash dryers. From the disintegration zone, the powder flows to the fluidization zone where the powder is dried to the desired moisture content. Finally powder and air are taken from the dryer system and separated using a cyclone or filter and optionally cooled.

The granular damage which is inflicted by the drying process is non-reversible. Non-inhibited granular amylopectin potato starch according to the invention can be rehydrated or otherwise equilibrated to equilibrium, moisture content (e.g. 18-20 wt. % moisture) under normal atmospheric conditions while retaining their favorable properties. Normal atmospheric conditions are defined by a temperature of 10-30° C. and a relative humidity of 40-75%.

The starch obtainable by the present drying process is surprisingly suitable for application in pasteurized meat products. Consequently, the invention furthermore provides a pasteurized meat product comprising a non-inhibited granular amylopectin potato starch as defined above.

A pasteurized meat product, in the present context, is a meat product which is based on animal-derived meat which is combined with water and preferably with at least a phosphate salt and/or a sodium or potassium chloride salt, most preferably a polyphosphate salt, which has been cooked to a core temperature of 70-80° C. The pasteurized meat product of the invention is preferably a ham, preferably a reconstituted ham or a whole muscle ham, a sausage, preferably a ground type sausage or an emulsified sausage, a nugget, a burger or a paté.

The combination with water and salt(s) is preferably achieved by tumbling, emulsifying or other types of mixing (for various types of comminuted (ground, chopped or otherwise particulated) meat), as well as by injection (in the case of whole meat). The combination with water and salt(s) is preferably achieved at a temperature of less than 10° C., preferably 0.5-8° C. more preferably 1-5° C.

The crude meat product is subsequently cooked to a core temperature of 70-80° C., preferably 71-78° C., more preferably 72-75° C., in a suitable container where necessary. The pasteurized meat product is preferably stored at relatively low temperatures until consumption, such as a temperature of less than 10° C., preferably 0.5-8° C., more preferably 1-5° C.

The invention furthermore provides a method for preparing a pasteurized meat product, comprising providing a mixture comprising water, meat, a phosphate salt and/or a sodium or potassium chloride salt, most preferably a polyphosphate salt and a non-inhibited granular amylopectin potato starch as defined above to obtain a meat product, followed by a thermal treatment of the said meat product to a core temperature of 70-80° C.

If the pasteurized meat product is an injected ham, said providing a mixture comprises injecting a mixture of water, a phosphate salt and/or a sodium or potassium chloride salt, most preferably a polyphosphate salt, the non-inhibited granular amylopectin potato starch and further optional components into whole raw muscle meat.

If the pasteurized meat product is a reconstituted ham, a sausage or a pate, said providing a mixture comprises mixing, preferably tumbling, emulsifying, shaking, stirring or extruding, of comminuted (ground, chopped or otherwise particulated) raw meat, water, a phosphate salt and/or a sodium or potassium chloride salt, most preferably a polyphosphate salt, the non-inhibited granular amylopectin potato starch and further optional components.

In preferred embodiments, the pasteurized meat product comprises a quantity of non-inhibited granular amylopectin potato starch of 1-15 wt. %, preferably 4-10 wt. %, based on dry solids.

In further preferred embodiments, the pasteurized meat product optionally comprises one or more of the following ingredients:
one or more salts, preferably selected from sodium chloride, potassium chloride, sodium polyphosphate, potassium polyphosphate, sodium nitrite, potassium nitrite, sodium acetate, potassium acetate, sodium lactate, potassium lactate, sodium erythorbate, potassium erythorbate;
one or more gelling agents, preferably selected from a hydrocolloid, such as carrageenan, gelatin, starch, pectin, carboxymethyl cellulose, methyl cellulose, hydroxypropyl cellulose, Arabic gum, xanthan, guar gum, locust bean gum, tara gum, konjac mannan, or a vegetable protein gelling agent, such as native soy protein, native pea protein or native potato protein;
one or more sweeteners, preferably selected from the group of dextrose, sucrose, glucose, lactose, fructose, aspartame and saccharin
one or more fibers, preferably selected from the group of lignin, cellulose, hemicellulose, fructo-oligosaccharides, galacto-oligosaccharides and resistant starch;
one or more antioxidants, preferably selected from the group of butylated hydroxytoluene (BHT), butylated hydroxyanisole (BHA), propyl gallate (PG) or tertiary butylhydroquinone (TBHQ), a phenolic acid, a phenolic diterpene, a flavonoid, a volatile oil, a carotenoids, vitamin A, vitamin C and vitamin E, and a bioactive peptide, and/or an extract of clove, rosemary, oregano, nutmeg, sage, cinnamon, grape, blue berries, strawberries and citrus;
one or more spices, preferably selected from ground pepper, parsley, paprika, garlic, fennel, thyme, cumin, nutmeg, bay leave, mustard, ginger, sage, dill, oregano, rosemary, and celery;

The quantities of the optional ingredients listed above may vary within wide limits, and are generally known to the person skilled in the art of preparing pasteurized meat products.

It is an advantage of a pasteurized meat product of the invention that it has one or more of the following characteristics:
Water holding, defined as the surface area of a cut face of a portion of a pasteurized meat product divided by the wetted surface area obtained from placing said cut face on a filter paper after 4 hours, multiplied by 100, which is higher than the water holding of an identical meat product prepared using a native granular amylopectin potato starch which has not been dried to 2-12 wt. %; and
Firmness, defined as the result obtained from a compression test on meat product using a Shimadzu texture analyzer with an 8 mm probe, which is higher than the firmness of an identical meat product prepared using a native granular amylopectin potato starch which has not been dried to 2-12 wt. %.

It is noteworthy that other granular starch types, when subjected to the drying method of the invention, do not result in the improved performance in pasteurized meat products described herein. Maize starch and tapioca starch for example, when processed identically to the native granular amylopectin potato starch, display more or less constant water holding when applied in a meat product. It appears the effect of drying of starch on water holding and firmness in a meat product is specific for granular amylopectin potato starch, and does not occur in other starch types.

For the purpose of clarity and a concise description features are described herein as part of the same or separate embodiments, however, it will be appreciated that the scope of the invention may include embodiments having combinations of all or some of the features described. The invention will now be illustrated by the following, non-limiting examples.

### EXAMPLES

### Example 1—Effects of Drying to a Moisture Content of 2-12 wt. %

The properties of the starch of the invention were compared to multiple closely related starch types, all at equilibrium moisture content under standard laboratory conditions (20±2° C., 40-60% relative humidity).

Starches evaluated for their properties included:
NPS: native granular potato starch (80 wt. % (of dry solids) amylopectin; potato starch, Avebe).
APS: native granular amylopectin potato starch (>98 wt. % amylopectin; Eliane 100, Avebe. Equilibrium moisture content under standard laboratory conditions 19 wt. %).
OD4: oven dried granular amylopectin potato starch (4 wt. % moisture, non-inhibited). OD4 was prepared by oven-drying a granular amylopectin potato starch (19.7% moisture) at a temperature of 80° C. for about five hours and subsequent cooling and equilibration to standard laboratory conditions for at least 4 hours.
Pn3: pneumatically dried granular amylopectin potato starch (dried to 3 wt. % moisture, non-inhibited). Pn3 was prepared by drying granular amylopectin potato starch (19.7% moisture) in a steam-heated pneumatic dryer (VTK), at an inlet temperature of 120° C. and an outlet temperature of 100° C., to a moisture content of 3 wt. %.
Pn8: pneumatically dried granular amylopectin potato starch (dried to 8 wt. % moisture, non-inhibited. Pn8 was prepared by drying granular amylopectin potato starch (19.7% moisture) in a steam-heated pneumatic dryer (VTK), at an inlet temperature of 120° C. and an outlet temperature of 75° C., to a moisture content of 8 wt. %.
TIPS: thermally inhibited granular potato starch (80 wt. % amylopectin; prepared by suspending the starch in a slurry comprising 1 part starch and 1.5 parts water, adjusted to pH 9.5 using a 5 wt. % Na₂CO₃ solution, which was agitated for 1 hour and then filtered, dried and ground, and subsequently inhibited in an oven at 160° C. for 60 minutes, and allowed to cool and attain equilibrium moisture content.
TIAPS: thermally inhibited amylopectin potato starch. Waxy potato starch is slurried in 1.5 equivalents water and brought to pH 9.0 with Na₂CO₃. The slurry is stirred for one hour and filtered on a Buchner funnel. The filter cake is dried at room temperature for 3 days, and subsequently milled in a Retsch GM 300. The product is subsequently further dried in a Retsch hot air dryer for 75 min at 90° C., to a moisture content of less than 2 wt. %. The dried starch is inhibited in a rotating drum for 180 minutes at 165° C., and subsequently cooled and allowed to reach equilibrium moisture content.
Liu OD1 and Liu OD6 (comparative): Oven-dried amylopectin potato starch according to Liu. Waxy potato starch (Avebe, the Netherlands) was suspended in water and the pH was set to 7. The starch was collected and dried to a regular moisture content of 19.7%. The dried starch granules were heated in an oven set to 110° C. for 2.5 hours. After 50 minutes, a quantity of starch was taken from the oven for analysis; the time of 50 minutes was chosen because this results in a starch having a moisture content of 6.1 wt. % (OD6). After 2.5 hours, the starch prepared according to Liu had a moisture content of 0.7% (OD1). Subsequently, the starches were cooled and equilibrated to standard laboratory conditions for at least 4 hours.

### Gelatinization Temperature (RVA at 30 wt. % Dry Solids).

The gelatinization temperature (Tg) of a starch was determined using a Rapid Visco Analyzer (RVA) from Newport Scientific. A quantity of 30 wt. % starch (dry weight) was suspended in regular mains water at room temperature in a total weight of 25 g and stirred at 960 rpm for 30 s while heating to a temperature of 30° C. Subsequently, the stirring speed was reduced to 160 rpm and the sample was subjected to a linear temperature increase at 0.84° C./min until gelatinization occurred, and the Tg was recorded. The gelatinization temperature is the temperature at which the viscosity increases to 100 mPa·s above the base line, from which temperature onwards the starch starts to significantly absorb water.

### Peak Viscosity (RVA at 6.4 wt. % Dry Solids)

The peak viscosity of a starch was determined using an RVA at 6.4 wt. % solids (dry weight) in regular mains water in a total volume of 27 g. The suspension was heated to a temperature of 45° C. while stirring at 960 rpm for 10 s. The speed was reduced to 160 rpm and heating at 45° C. was continued for another 50 s. Then the temperature was linearly increased at 5.0° C./min to 95° C. while stirring at 160 rpm, whereupon the temperature was held at 95° C. for 6 minutes (holding phase) prior to linear cooling to 40° C. at 10° C./min (cooling phase). The temperature was held at 40° C. for 3 minutes (holding phase). The viscosity of the sample was monitored in mPa s, and the peak viscosity as well as the viscosity at the end of the holding phase were recorded. Peak viscosity is a measure for swelling strength of a granule, an important attribute for water holding of a meat product.

### Breakdown

The breakdown of a starch was determined from the RVA results obtained at 6.4 wt. % dry solids. Breakdown reflects the decrease in viscosity relative to peak viscosity, and is therefore a measure for how well a starch granule is disrupted. This is an important aspect of water holding.

### Breakdown is Defined as:

$$Breakdown [ \% ] = \frac{Peak viscosity [ mPas ] - Viscisoty End holding phase [ mPas ]}{Peak viscosity [ mPas ]} * 100 \%$$

### Enzymatic Digestibility

Enzymatic digestibility or “digestibility” is measured using the standardized amylase degradation method:

### Materials

0.1 M sodium acetate buffer+0.005 M CaCl₂) pH 5.0
0.1 M sodium acetate buffer pH 5.0
0.2% (v/v) Sulfuric acid
α-amylase, enzyme activity 3000 U/ml, Megazyme cat. no. E-BLAAM
Amylogucosidase, enzyme activity 3260 U/ml, cat.no. E-AMAIGDF
D-Glucose testkit: D-Glucose-HK testkit, Megazyme cat.o. K-GLUHKR containing:
   Bottle 1: Buffer+sodium azide
   Bottle 2: NADP++ATP before use dissolve the powder in 12 ml of water
   Bottle 3: Hexokinase+Glucose6 phosphate dehydrogenase (suspension)

### Procedure

Weigh out in a centrifuge tube (15 ml) minimal 0.095 and maximal 0.105 g of starch with an accuracy of 0.1 mg
Prepare α-amylase solution immediately before analysis by pipetting 0.100 ml α-amylase in 50 ml sodium acetate buffer pH 5.0+0.005 M CaCl₂). Homogenize and dilute further by pipetting 0.5 ml of the former solution to 9.5 ml sodium acetate buffer pH 5.0+0.005 CaCl₂) and homogenize.
Heat the diluted α-amylase solution for 5 minutes in a waterbath at 40° C.
Add 1 ml of the preheated α-amylase solution to centrifuge tube containing the starch, cap the tub, mix for 5 seconds on a Vortex and immediately put the tube in the waterbath at 40° C.
After exactly 10 minutes remove the tube form the waterbath, add 5 ml of 0.2% (v/v) sulfuric acid and mix carefully.
After standing for 5 minutes at ambient temperature centrifuge for 5 minutes at 2000 g.
Pipet 0.5 ml of the clear supernatant in a clean centrifuge tube
Prepare a diluted amyloglucosidase solution by pipetting 0.150 ml amyloglucosidase to 10.00 ml 0.1 M sodium acetate buffer pH 5.0
Pipet 0.5 ml of the diluted amyloglucosidase to the clear supernatant solution and mix carefully.
Place the centrifuge tube in the waterbath at 40° C. and heat for 10 minutes.
Remove the centrifuge tube from the waterbath, cool to ambient temperature, add 4 ml of water and homogenize
Use this solution (Vm) for determination of the glucose content (see below)

### Glucose Content Determination:

Pipet into a plastic cuvet 1.6 ml of water, 0.50 ml of solution Vm, 0.10 ml from bottle 1 and 0.10 ml from bottle 2 solution of the testkit and homogenize.
After 3 minutes measure the absorption at 340 nm against air (A1)
Add 20 microliters from bottle 3 from the testkit, homogenize and after minimal 5 minutes measure absorption again (A2).

From the differences of both absorptions the enzymatic digestability is determined by

$$digestibility = \frac{{V}_{t} \times {M}_{g}}{ε \times d \times {V}_{m}} \times ( {A}_{2} - {A}_{1} ) \times \frac{0 , 006 \times 10 \times 0 , 9}{{m}_{m}}$$

$$( digestibility = 7 , 165 \times \frac{( {A}_{2} - {A}_{1} )}{{m}_{m}} )$$

### Wherein

Digestibility=released starch quantity in mg/g solids;
Vₜ=total test volume (=2.32 ml);
M_{g}=glucose molecular weight (=180.16 g/mol);
ε=molar absorptiecoafficient of NADPH bij 340 nm (6.3 [1×mmol⁻¹×cm⁻¹]);
d=optical path length (1 cm);
Vₘ=quantity of supernatant solution (=0.50 ml);
A₁=absorption at 340 nm after 3 minutes;
A₂=absorption at 340 nm after 5 minutes;
0.006=conversion factor;
10=conversion factor;
0.9=conversion factor;
Mₘ=mass of starch in g.

Enzymatic digestibility reflects the amount of starch that leaches out the starch granules and that is able to bind free water before the temperature reaches the point where the starch granule starts to gelatinize. Preferably there should leach out some starch to bind water released by the meat proteins. Water binding at this stage is important to enhance firmness as the meat proteins will denature in a more dense environment. However, if the amount of starch that is released is too large, the meat enzymes will degrade large proportions of starch, leading to a reduction in molecular weight, which will cause a reduction in water holding capacity.

### Light Microscopy

Light microscopy of starch samples was performed by introducing the sample between two glass plates and pressing with a weight of 3500 g for 2 seconds and simultaneously moving the glass plates 5 times by 5 mm back and forth. The sample was subsequently visualized using an Olympus U-TV1 X light microscope at 10×/0.25 magnification.

### Results

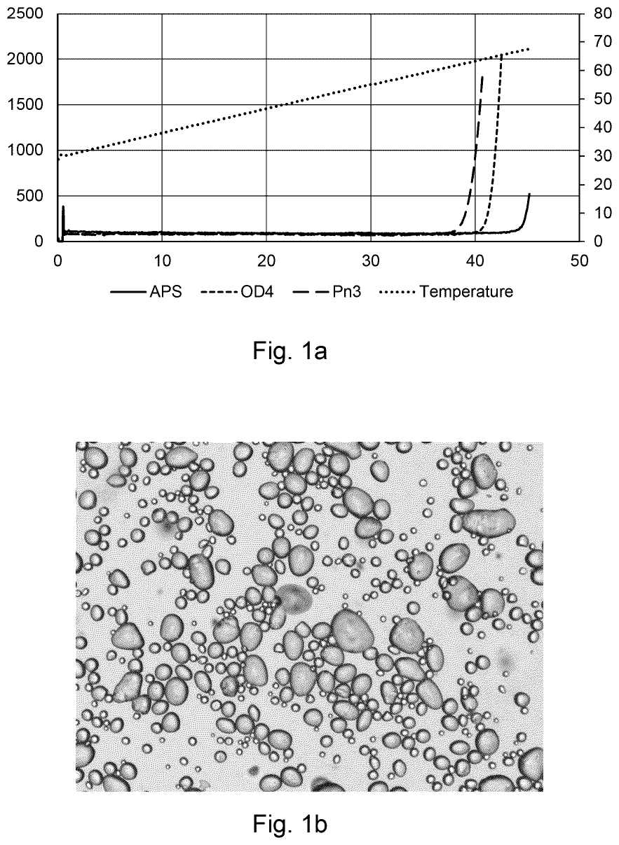

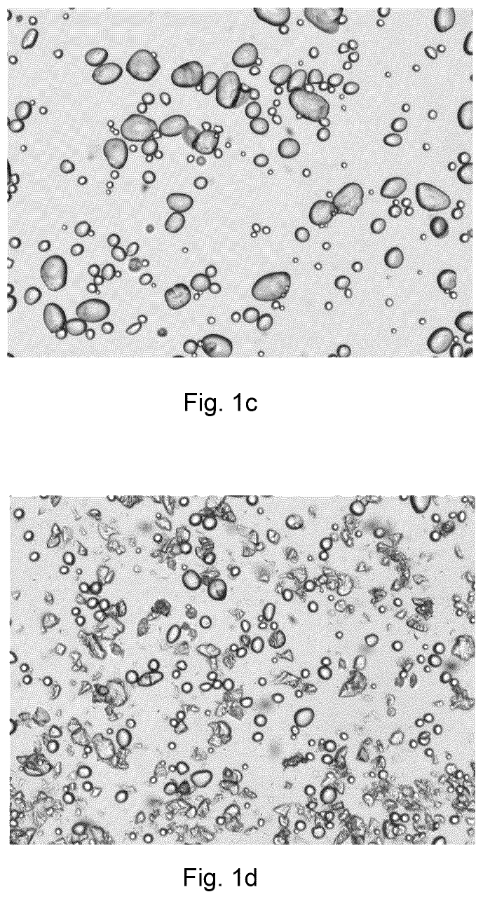

The starch types listed above were subjected to comparative analysis for Tg, enzymatic digestibility, peak viscosity and breakdown. The results are shown in table 1 (FIG. 1a):

TABLE 1

| | Tg RVA | Enz. Dig. | Breakdown | Peak visc |
|---|---|---|---|---|
| | at 30% | [mg/g dry | RVA at 6.4% | RVA at 6.4% |
| | [° C.] | solids] | [%] | [mPas] |
| NPS | 61.3 | 9.8 | 46.4 | 2508 |
| APS | 67.1 | 8.4 | 64.7 | 3479 |
| Pn3 | 62.1 | 14.4 | 67.4 | 3688 |
| Pn8 | 63.4 | 10.1 | 65.9 | 3844 |
| OD4 | 64.0 | 9 | 66.6 | 3688 |
| TIPS | 58.4 | 19.2 | 24.8 | 1511 |
| TIAPS | 58.9 | 19.3 | 27.7 | 2926 |
| Liu OD6 | 63.9 | 10.7 | 65.0 | 3623 |
| Liu OD1 | 61.2 | 11.5 | 66.0 | 3735 |

It is clear from the table that drying to a moisture content of 2-12 wt. % has the result that Tg is reduced to a comparable level as regular potato starch, relative to the non-dried (APS) starch. At the same time, enzymatic digestibility is increased. This indicates that water holding of granular amylopectin potato starch has improved by the process of drying to 2-12 wt. %, while at the same time the water holding occurs at lower temperature. Peak viscosity however is maintained, reflective of strong water absorption.

Inhibited starch types do not display these effects: inhibited starch types TIPS and TIAPS have higher enzymatic digestibility and (much) lower breakdown, which indicates that inhibition precludes proper granule disruption.

The APS, Pn3 and OD4 samples were also visualized using a light microscope. It is clearly visible that APS retains its granular structure after pressing, whereas OD4 displays granular cracks. Pn3 not only displays cracks after pressing, but also has become partially fragmented (FIG. 1b-d). Thus, drying the granules to a moisture content of 2-12 wt. % increases the fragmentability of the granules, in particular when concomitant stress is applied, such as by pneumatic drying.

### Example 2—Effects of Granular Amylopectin Potato Starch Dried to a Moisture Content of 2-12 wt. % in a Meat Product

### Preparation of Meat Products

The advantages of a starch of the invention were shown in an exemplary meat product: a cooked ham. The cooked ham was prepared on the basis of the below ingredients:

| Ingredients | Wt. % |
|---|---|
| Pork meat | 35.7 |
| Water | 55.7 |
| Salt | 1.8 |
| Sodium tripolyphosphate | 0.4 |
| Starch* | 6.0 |
| Carrageenan (semirefined) | 0.4 |
| TOTAL | 100.0 |

*starch is used at 6.0 wt % concentration based on dry solid content

A brine was prepared by dissolving 0.72 wt. % sodium tripolyphosphate in regular mains water at 4° C., and subsequent addition of 3.2 wt. % salt (NaCl), 0.72 wt. % carrageenan and 10.8 wt. % (dry solids) of the starch. The brine was tumbled under vacuum in a tumbler with fresh pork meat (ham region) obtained from a local butcher, which had been ground to 8 mm size pieces using a plate with 8 mm holes for 45 min. The obtained crude meat mixture was filled into cans in 450 g portions which were pasteurized in a water bath at 75° C. or 80° C., until reaching a core temperature of 74° C. The cans were cooled in ice water and stored in a refrigerator at 4° C. Meat products were prepared using starches of the invention or using a comparative starch, all at equilibrium moisture content under standard laboratory conditions (20±2° C., 40-60% humidity). Water holding and firmness of the meat product were determined for each starch type. Due to inherent variability in the composition of the pork meat used to prepare the meat product (mainly fat content), water holding and firmness were also expressed relative to the water holding and fat content of the meat product using the same type of starch prior to drying to 2-12 wt. %, where applicable.

Water Holding Water holding of a meat product was analyzed by placing a fresh side of a 73 mm radius cylindrical block of ham on a filter paper (Schleicher & Schuell 595, 125 mm filter paper circles), and measuring the surface area of the wetted portion of the paper after 4 hours under standard laboratory conditions (20 ±2° C., 40-60% humidity). Water holding was calculated as the surface area of the cut face of the ham divided by the wetted surface area of the filter paper, multiplied by 100.

### Firmness

Firmness of the ham was evaluated by compression measurements using a Shimatzu texture analyzer (Shimatzu EZ-SX Food Texture Analyzer) using eight compression-type measurements per can with an 8 mm probe. The capacity was 500 N and the test speed 1 mm/s, as compared to a stroke-type control.

### Results

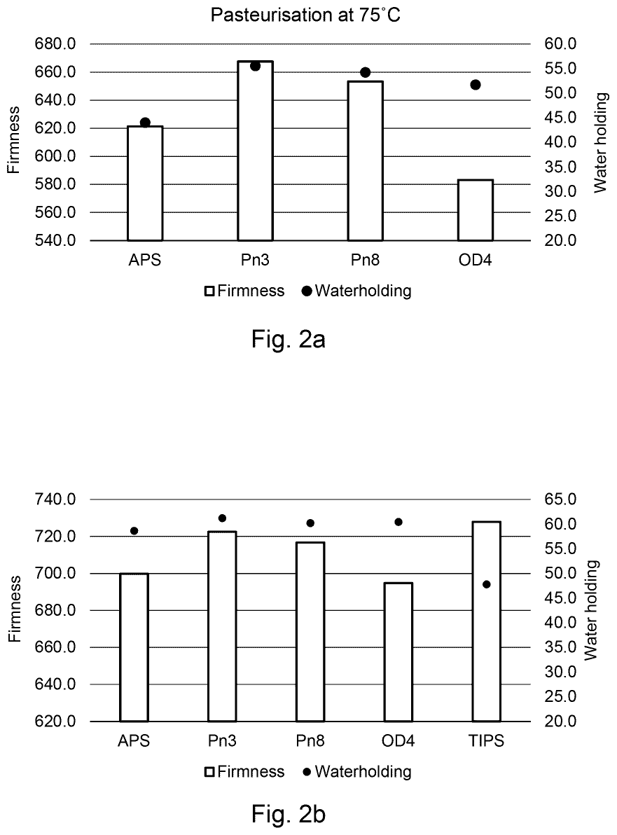

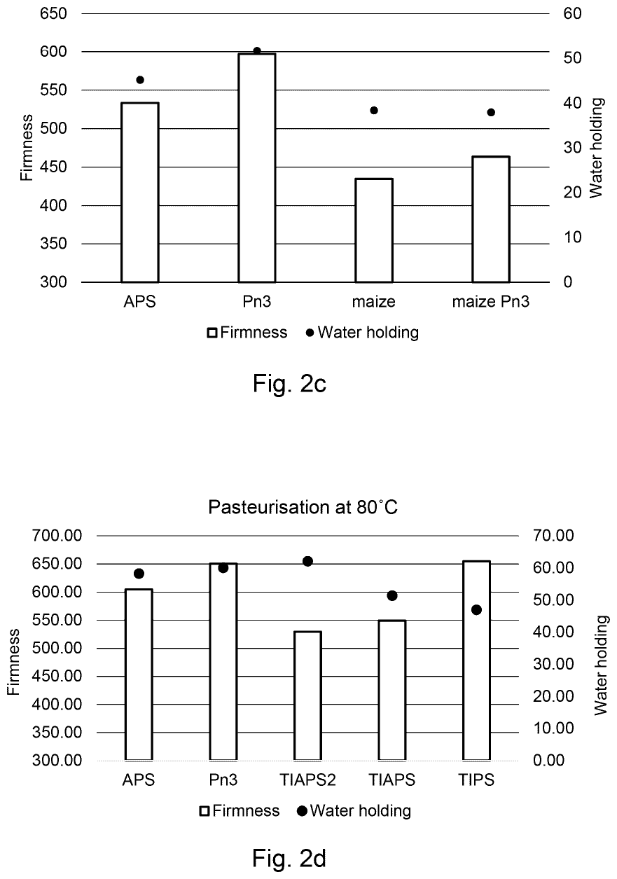

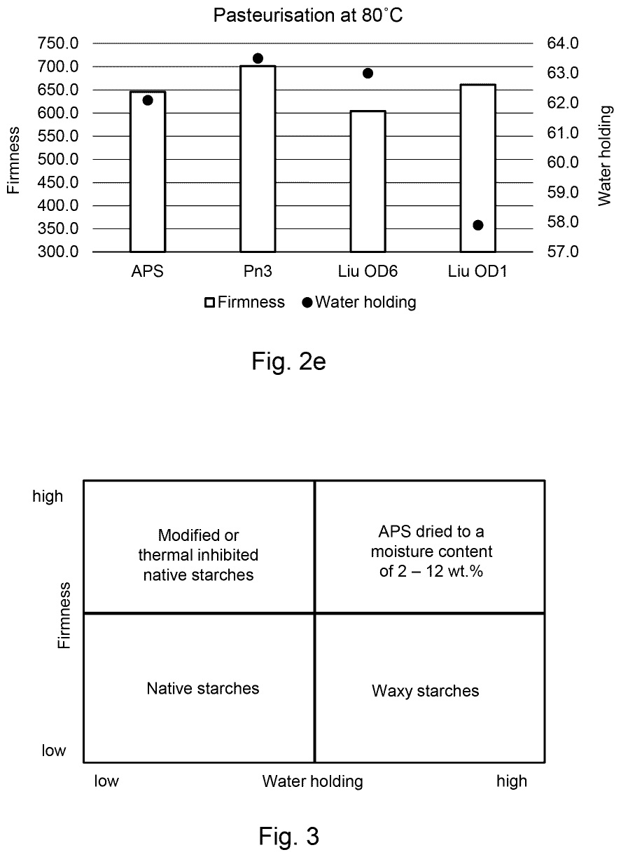

Using a first batch of pork meat (experiment 2a), a meat product was prepared using APS, Pn3, Pn8 and OD4 as defined in example 1. The meat product was pasteurized at 75° C. The results are provided in table 2 (FIG. 2a):

TABLE 2

| Pasteurization | Water | | | |
|---|---|---|---|---|
| at 75 C. | holding | % | Firmness | % |
| APS | 44.0 | 100 | 621.4 | 100 |
| Pn3 | 55.6 | 126.3 | 667.6 | 107.4 |
| Pn8 | 54.3 | 123.3 | 653.4 | 105.2 |
| OD4 | 51.7 | 117.6 | 583.1 | 93.8 |

The results show that by drying a granular amylopectin potato starch to a water content of 2-12 wt. % under stress, both water holding and firmness of the meat product is increased. A starch of the invention provides a significant improvement on both aspects.

In experiment 2b, meat products were prepared on the basis of the same starch types but pasteurized at 80° C. The results are provided in table 3 (FIG. 2b):

TABLE 3

| Pasteurization | Water | | | |
|---|---|---|---|---|
| at 80 C. | holding | % | Firmness | % |
| APS | 58.7 | 100 | 699.8 | 100 |
| Pn3 | 61.2 | 104.4 | 722.5 | 116.3 |
| Pn8 | 60.2 | 102.7 | 716.8 | 115.4 |
| OD4 | 60.4 | 103.0 | 694.8 | 111.8 |
| TIPS | 47.8 | 81.5 | 727.8 | 104.0 |

The results show that by drying a granular amylopectin potato starch to a water content of 2-12 wt. % under stress, both water holding and firmness of the meat product is increased. In contrast, an inhibited potato starch results in lower water holding, compared to both APS and to starch of the invention.

It can furthermore be seen from the two experiments that a higher pasteurization temperature results in a more favorable impact of drying on the firmness, whereas a lower pasteurization temperature results in a more favorable impact of drying on water holding.

A third experiment (experiment 2c) was performed to evaluate whether the observed effect of drying also occurs in other amylopectin starch types. The same types of potato starch were used, and compared to a granular amylopectin maize starch, which was dried to a moisture content of 2-12 wt. % in an identical way as Pn3 (“maize and “maize Pn3”). The four starch types were compared in a meat product following the same recipe and using the same ground batch of meat, which was pasteurized at 80° C. The results are shown in table 4 (FIG. 2c):

TABLE 4

| Pasteurization | Water | | | |
|---|---|---|---|---|
| at 80 C. | holding | % | Firmness | % |
| APS | 45.14 | 100 | 533.4 | 100 |
| Pn3 | 51.7 | 114.6 | 596.9 | 111.9 |
| maize | 38.4 | 100 | 434.7 | 100 |
| maize Pn3 | 37.9 | 98.9 | 463.5 | 106.6 |

It follows from table 4 that the favorable effect of drying to a moisture content of 2-12 wt. % under physical stress does not occur in waxy maize starch. An identical treatment on granular waxy potato starch and on granular waxy maize starch results in opposite effects: non-inhibited dried granular amylopectin potato starch results in an increased water holding and firmness in a meat product, whereas non-inhibited dried granular amylopectin maize starch results in decreased water holding in a meat product.

In a fourth experiment (experiment 2d), a comparison with an inhibited amylopectin potato starch was included. The inhibited amylopectin potato starch had only been inhibited to a minimal degree; it was prepared following the preparation method for TIAPS in example 1, but the inhibition was performed in a rotating drum for 45 minutes at 150° C. (“TIAPS2”). The results are provided in table 5 (FIG. 2d):

TABLE 5

| Pasteurization | Water | | | |
|---|---|---|---|---|
| at 80 C. | holding | % | Firmness | % |
| APS | 58.3 | 100.0 | 605.0 | 100.0 |
| Pn3 | 60.1 | 103.1 | 650.5 | 107.5 |
| TIAPS2 | 62.1 | 106.6 | 529.6 | 87.5 |
| TIAPS | 51.4 | 82.9 | 549.2 | 88.5 |
| TIPS | 47.0 | 80.6 | 655.1 | 108.3. |

The results show that even minor inhibition results in a much decreased firmness, whereas drying to a moisture content without inhibition results in both increased firmness and increased water holding.

In a fifth experiment (experiment 2e), a comparison with oven dried starches dried at 110° C. according to Liu was made. Pasteurization of the meat product was performed at 80° C. The results are provided in table 6 (FIG. 2e):

TABLE 6

| Pasteurization | Water | | | |
|---|---|---|---|---|
| at 80 C. | holding | % | Firmness | % |
| APS | 62.1 | 100.0 | 645.8 | 100.0 |
| Pn3 | 63.5 | 102.3 | 701.0 | 109.4 |
| Liu OD6 | 63.0 | 101.4 | 604.2 | 94.3 |
| Liu OD1 | 57.9 | 93.2 | 661.1 | 103.2 |

The results show that oven drying at 110° C. does not provide starches which increase both water holding and firmness of the meat product. With Liu OD6 water holding is slightly improved, but firmness decreases as compared to native amylopectin potato starch. With Liu OD1 firmness is better, but water holding is worse.

1. A non-inhibited granular amylopectin potato starch obtainable by a process comprising drying a native granular amylopectin potato starch to a moisture content of 2-12 wt. % under the application of physical stress, which non-inhibited granular amylopectin potato starch is characterized by a gelatinization temperature, measured using RVA at 30 wt. % dry solids, which is more than 2.5° C., lower than the gelatinization temperature of the native granular amylopectin potato starch prior to drying.

2. The non-inhibited granular amylopectin potato starch according to claim 1, having one or more of the following characteristics:
A gelatinization temperature, measured using RVA at 30 wt. % dry solids, of 59-65° C.; and/or
An enzymatic digestibility, measured using the standardized amylase degradation method, which is higher than the enzymatic digestibility of the native granular amylopectin potato starch prior to drying; and/or
An enzymatic digestibility, measured using the standardized amylase degradation method, of at least 8.5 mg/g dry substance; and/or
An enzymatic digestibility, measured using the standardized amylase degradation method, of 9-18 mg/g dry substance; and/or
A breakdown, measured using RVA at 6.4 wt. % dry solids, which is higher than the breakdown of the native granular amylopectin potato starch prior to drying; and/or
A breakdown, measured using RVA at 6.4 wt. % dry solids, of at least 65%; and/or
A breakdown, measured using RVA at 6.4 wt. % dry solids, of at least 65.5%; and/or
A peak viscosity, measured using RVA at 6.4 wt. % dry solids, which is higher than the peak viscosity of the native granular amylopectin potato starch prior to drying; and/or
A peak viscosity, measured using RVA at 6.4 wt. % dry solids, of at least 3500 mPa·s; and/or
A peak viscosity, measured using RVA at 6.4 wt. % dry solids, of at least 3550 mPa·s; and/or
A peak viscosity, measured using RVA at 6.4 wt. % dry solids, of at least 3600 mPa·5.

3. The non-inhibited granular amylopectin potato starch according to claim 1, obtainable by a process comprising drying a native granular amylopectin potato starch to a moisture content of 3-9 wt %.

4. The non-inhibited granular amylopectin potato starch according to claim 1, wherein said drying under the application of physical stress comprises comprising pneumatic drying, cyclone drying, dispersion drying or fluid bed drying.

5. The non-inhibited granular amylopectin potato starch according to claim 1, which after drying has been rehydrated to equilibrium moisture content under atmospheric conditions, defined by a temperature of 10-30° C. and a relative humidity of 40-75%.

6. A pasteurized meat product comprising a non-inhibited granular amylopectin potato starch as defined in claim 1.

7. The pasteurized meat product according to claim 6, wherein the quantity of non-inhibited granular amylopectin potato starch is 1-15 wt. %, based on dry solids.

8. The pasteurized meat product according to claim 6, further comprising meat and water, and furthermore optionally comprising one or more of the following ingredients:
one or more salts,
one or more gelling agents, selected from a hydrocolloid or a vegetable protein gelling agent;
one or more sweeteners,
one or more fibers,
one or more antioxidants,
one or more spices.

9. The pasteurized meat product according to claim 6, wherein the pasteurized meat product is a ham, a sausage, nugget, a burger or a paté.

10. The pasteurized meat product according to claim 6, having one or more of the following characteristics:
Water holding, defined as the surface area of a cut face of a portion of a pasteurized meat product divided by the wetted surface area obtained from placing said cut face on a filter paper after 4 hours, multiplied by 100, which is higher than the water holding of an identical meat product prepared using a native granular amylopectin potato starch which has not been dried to 2-12 wt. %; and
Firmness, defined as the result obtained from a compression test on meat product using a Shimadzu texture analyzer with an 8 mm probe, which is higher than the firmness of an identical meat product prepared using a native granular amylopectin potato starch which has not been dried to 2-12 wt. %.

11. A method for preparing a pasteurized meat product, comprising providing a mixture comprising water, meat, a phosphate salt and/or a sodium or potassium chloride salt, and a non-inhibited granular amylopectin potato starch as defined in claim 1 to obtain a meat product, followed by a thermal treatment of the said meat product to a core temperature of 65-90° C.

12. The method according to claim 11, wherein
If the pasteurized meat product is an injected ham, said providing a mixture comprises injecting a mixture of water, the phosphate salt and/or the sodium or potassium chloride salt, the non-inhibited granular amylopectin potato starch and further optional components into whole raw muscle meat;
If the pasteurized meat product is a reconstituted ham, a sausage or a pate, said providing a mixture comprises mixing, of comminuted raw meat, water, the phosphate salt and/or sodium or potassium chloride salt, the non-inhibited granular amylopectin potato starch and further optional components.

13. A method for obtaining a non-inhibited granular amylopectin potato starch as defined in claim 1, comprising drying native granular amylopectin potato starch at a temperature of at least 70° C., to a final moisture content of 2 to 12 wt % under the application of physical stress.

14. The method according to claim 13, wherein the method comprises pneumatic drying, cyclone drying, dispersion drying or fluid bed drying.

15. The method according to claim 13, wherein the native granular amylopectin potato starch prior to drying has a moisture content of higher than 15 wt % and/or wherein the method comprises pneumatic drying at an inlet temperature of 110-175° C. and an outlet temperature of 70-135° C.

16. The non-inhibited granular amylopectin potato starch according to claim 1, wherein the gelatinization temperature, measured using RVA at 30 wt. % dry solids, is 3-8° C. lower than the gelatinization temperature of the native granular amylopectin potato starch prior to drying.

17. The non-inhibited granular amylopectin potato starch according to claim 1, having at least two of the following characteristics:
A gelatinization temperature, measured using RVA at 30 wt. % dry solids, of 59-65° C.; and/or
An enzymatic digestibility, measured using the standardized amylase degradation method, which is higher than the enzymatic digestibility of the native granular amylopectin potato starch prior to drying; and/or
An enzymatic digestibility, measured using the standardized amylase degradation method, of at least 8.5 mg/g dry substance; and/or
An enzymatic digestibility, measured using the standardized amylase degradation method, of 9-18 mg/g dry substance; and/or
A breakdown, measured using RVA at 6.4 wt. % dry solids, which is higher than the breakdown of the native granular amylopectin potato starch prior to drying; and/or
A breakdown, measured using RVA at 6.4 wt. % dry solids, of at least 65%; and/or
A breakdown, measured using RVA at 6.4 wt. % dry solids, of at least 65.5%; and/or
A peak viscosity, measured using RVA at 6.4 wt. % dry solids, which is higher than the peak viscosity of the native granular amylopectin potato starch prior to drying; and/or
A peak viscosity, measured using RVA at 6.4 wt. % dry solids, of at least 3500 mPa·s; and/or
A peak viscosity, measured using RVA at 6.4 wt. % dry solids, of at least 3550 mPa·s; and/or
A peak viscosity, measured using RVA at 6.4 wt % dry solids, of at least 3600 mPa s.

18. The non-inhibited granular amylopectin potato starch according to claim 1, having all of the following characteristics:
A gelatinization temperature, measured using RVA at 30 wt. % dry solids, of 59-65° C.; and/or
An enzymatic digestibility, measured using the standardized amylase degradation method, which is higher than the enzymatic digestibility of the native granular amylopectin potato starch prior to drying; and/or
An enzymatic digestibility, measured using the standardized amylase degradation method, of at least 8.5 mg/g dry substance; and/or
An enzymatic digestibility, measured using the standardized amylase degradation method, of 9-18 mg/g dry substance; and/or
A breakdown, measured using RVA at 6.4 wt. % dry solids, which is higher than the breakdown of the native granular amylopectin potato starch prior to drying; and/or
A breakdown, measured using RVA at 6.4 wt. % dry solids, of at least 65%; and/or
A breakdown, measured using RVA at 6.4 wt. % dry solids, of at least 65.5%; and/or
A peak viscosity, measured using RVA at 6.4 wt. % dry solids, which is higher than the peak viscosity of the native granular amylopectin potato starch prior to drying; and/or
A peak viscosity, measured using RVA at 6.4 wt. % dry solids, of at least 3500 mPa·s; and/or
A peak viscosity, measured using RVA at 6.4 wt. % dry solids, of at least 3550 mPa·s; and/or
A peak viscosity, measured using RVA at 6.4 wt. % dry solids, of at least 3600 mPa·s.

19. The non-inhibited granular amylopectin potato starch according to claim 1, obtainable by a process comprising drying a native granular amylopectin potato starch to a moisture content of 3-7 wt. %.

20. The pasteurized meat product according to claim 6, wherein the quantity of non-inhibited granular amylopectin potato starch is 4-10 wt. %, based on dry solids.

21. The pasteurized meat product according to claim 6, further comprising ground or chopped meat and water, and furthermore optionally comprising one or more of the following ingredients:
one or more salts selected from sodium chloride, potassium chloride, sodium polyphosphate, potassium polyphosphate, sodium nitrite, potassium nitrite, sodium acetate, potassium acetate, sodium lactate, potassium lactate, sodium erythorbate, potassium erythorbate;
one or more gelling agents selected from the hydrocolloids carrageenan, gelatin, starch, pectin, carboxymethyl cellulose, methyl cellulose, hydroxypropyl cellulose, Arabic gum, xanthan, guar gum, locust bean gum, tara gum, konjac mannan, or from the vegetable protein gelling agents native soy protein, native pea protein or native potato protein;
one or more sweeteners selected from the group of dextrose, sucrose, glucose, lactose, fructose, aspartame and saccharin
one or more fibers selected from the group of lignin, cellulose, hemicellulose, fructo-oligosaccharides, galacto-oligosaccharides and resistant starch;
one or more antioxidants selected from the group of butylated hydroxytoluene (BHT), butylated hydroxyanisole (BHA), propyl gallate (PG) or tertiary butylhydroquinone (TBHQ), a phenolic acid, a phenolic diterpene, a flavonoid, a volatile oil, a carotenoids, vitamin A, vitamin C and vitamin E, and a bioactive peptide, and/or an extract of clove, rosemary, oregano, nutmeg, sage, cinnamon, grape, blue berries, strawberries and citrus;
one or more spices selected from ground pepper, parsley, paprika, garlic, fennel, thyme, cumin, nutmeg, bay leave, mustard, ginger, sage, dill, oregano, rosemary, and celery.

22. The pasteurized meat product according to claim 6, wherein the pasteurized meat product is a reconstituted ham or a whole muscle ham, a ground type sausage or an emulsified sausage.

23. The method for preparing a pasteurized meat product according to claim 11, wherein the phosphate salt is a polyphosphate salt.

24. The method for preparing a pasteurized meat product according to claim 11, wherein the thermal treatment of the said meat product is to a core temperature of 70-80° C.

25. The method according to claim 11, wherein if the pasteurized meat product is a reconstituted ham, a sausage or a pate, said mixing comprises tumbling, shaking, stirring or extruding, of the comminuted raw meat, water, the phosphate salt and/or sodium or potassium chloride salt, the non-inhibited granular amylopectin potato starch and further optional components.

26. The method for obtaining a non-inhibited granular amylopectin potato starch according to claim 13, comprising drying native granular amylopectin potato starch at a temperature of 125-175° C. to a final moisture content of 3-9 wt. % under the application of physical stress.

27. The method according to claim 13, wherein the native granular amylopectin potato starch prior to drying has a moisture content of higher than 18 wt. %, and/or wherein the method comprises pneumatic drying at an inlet temperature of 140-175° C., and an outlet temperature of 75-125° C.
